(19) United States
(12) Patent Application Publication
(10) Pub. No.: US 2023/0267206 A1
(43) Pub. Date: Aug. 24, 2023

(54) MITIGATION OF A MANIPULATION OF SOFTWARE OF A VEHICLE

(71) Applicant: Robert Bosch GmbH, Stuttgart (DE)

(72) Inventors: Felix Hallaczek, Stuttgart (DE); Manuel Jauss, Wissgoldingen (DE); Marcel Kneib, Ingelheim (DE)

(21) Appl. No.: 18/170,405

(22) Filed: Feb. 16, 2023

(30) Foreign Application Priority Data
Feb. 23, 2022 (DE) 10 2022 201 895.8

(51) Int. Cl. G06F 21/56; G06F 21/55

(52) U.S. Cl. CPC G06F 21/566; G06F 21/554; G06F 2221/033

(57) ABSTRACT

A computer-implemented method. The method includes recognizing the possibility of a manipulation of the software of a first component of a plurality of components of a vehicle electrical system of a vehicle in a central device for mitigating a manipulation of software. The central device is part of the vehicle electrical system, and mitigates a manipulation of software in each component of the plurality of components. The method further includes initiating a countermeasure for mitigating the manipulation of the software of the first component by the central device; and carrying out the countermeasure for mitigating the manipulation of the software of the first component. The countermeasure for mitigating the manipulation includes a measure for preventing a repetition of the manipulation, which is selected based on an analysis of information concerning data traffic in the vehicle electrical system that took place before the possibility of a manipulation was recognized.

### CROSS REFERENCE

The present application claims the benefit under 35 U.S.C. § 119 of German Patent Application No. DE 10 2022 201 895.8 filed on Feb. 23, 2022, which is expressly incorporated herein by reference in its entirety.

### BACKGROUND INFORMATION

In recent times, vehicles are being increasingly integrated into open contexts (i.e., the vehicles include one or multiple interfaces via which data are received and/or sent during operation and in turn used for operating the vehicle). In addition, the complexity of the components of the vehicles, and in particular their software, is continually increasing.

As a result, there are more possibilities for manipulating the software of the components of the vehicles.

In some methods of the related art, the detection and in particular the mitigation (i.e., remedying, so that a defined (secure) state is achieved) of manipulations are associated with significant complexity and thus, time delays. For example, during a visit to a repair shop the manipulated software of a component (a control unit, for example) may be reset and the manipulation may thus be remedied. In other techniques, software from a remote computer system may be requested, with the aid of which the manipulated software of a component (a control unit, for example) is reset and the manipulation is thus remedied. In both cases, there may be a significant period of time between detecting the manipulation and mitigating the manipulation.

During this time period, the operation of the vehicle may be disrupted (for example, a predetermined safety criterion is no longer met). In some cases, the vehicle may no longer be roadworthy, or its functionality may be greatly impaired. Therefore, improved techniques for mitigating the manipulation of software are desirable.

### SUMMARY

A first general aspect of the present invention relates to a computer-implemented method. According to an example embodiment of the present invention, the method includes recognizing the possibility of a manipulation of the software of a first component of a plurality of components of a vehicle electrical system of a vehicle in a central device for mitigating a manipulation of software. The central device for mitigating a manipulation is part of the vehicle electrical system, and is designed to mitigate a manipulation of software in each component of the plurality of components of the vehicle electrical system. The method further includes initiating a countermeasure for mitigating the manipulation of the software of the first component and carrying out the countermeasure for mitigating the manipulation of the software of the first component. The countermeasure for mitigating the manipulation includes a measure for preventing a repetition of the manipulation, which is selected based on an analysis of information concerning data traffic in the vehicle electrical system that took place before the possibility of a manipulation was recognized.

A second general aspect of the present invention relates to a system that is designed to carry out the method according to the first general aspect of the present invention.

A third general aspect of the present invention relates to a vehicle electrical system for a vehicle. According to an example embodiment of the present invention, the vehicle electrical system includes a plurality of components that involve a first component and a central device for mitigating a manipulation of software. The vehicle electrical system is designed to carry out the method according to the first general aspect of the present invention.

A fourth general aspect of the present invention relates to a vehicle that includes the system according to the second general aspect of the present invention and/or is a part of same, and/or includes the vehicle electrical system according to the third general aspect of the present invention.

The techniques of the first through fourth general aspects of the present invention may in some cases have one or more of the following advantages.

Firstly, by use of the techniques of the present disclosure, a vehicle electrical system of a vehicle and optionally of further vehicles may be safeguarded from (repeated) manipulations. Thus, in some situations a manipulation of the vehicle electrical system of the vehicle may in fact be remedied by a countermeasure. For example, resetting manipulated software may initially put the vehicle electrical system into a secure state. However, a weak point may still remain in the vehicle electrical system, which possibly may be exploited by an intruder for a renewed attack. For example, a weak point may be created via an insufficiently secured interface of the vehicle electrical system, which the intruder may exploit for introducing the manipulated software. The techniques of the present disclosure may address this problem in some situations by carrying out a measure for preventing the repetition of a recognized manipulation. The measure is selected based on an analysis of information concerning data traffic in the vehicle electrical system that took place before the possibility of the manipulation was recognized. This information concerning the data traffic may allow conclusions as to which channel an intruder has employed to manipulate the software. The countermeasure may now involve the identified channel in a targeted manner. For example, an interface via which data have (presumably) been transmitted prior to the manipulation of the software of the component may be deactivated. In this way, an intruder may be prevented from repeatedly exploiting the weak point.

Secondly, by selecting a targeted measure for preventing the repetition of a manipulation, in some situations a functionality of the vehicle electrical system may be retained to a greater extent compared to carrying out other countermeasures. For example, for safe operation of the vehicle, it may be sufficient to deactivate a certain interface via which multiple components of the vehicle electrical system have been manipulated. If this interface is closed, in some cases the multiple components may continue to be operated (optionally after resetting the software of the components or further countermeasures). The functionality of a vehicle may thus be available to a greater extent compared to a situation in which, for example, the affected components are deactivated.

Several terms are used as follows in the present disclosure:

In the present disclosure, a “component” (of a vehicle electrical system) includes its own hardware resources, which include at least one processor for executing commands, and memory for storing at least one software component. The term “processor” also encompasses multicore processors or multiple separate elements that take over the tasks of a central processing unit of an electronic device (and optionally share same). A component may carry out tasks independently (for example, measuring tasks, monitoring tasks, control tasks, communication tasks, and/or other work tasks). However, in some examples, a component may also be controlled by another component. A component may be physically delimited (with its own housing, for example) or may be integrated into a higher-order system. A component may be a control unit or a communication device of the vehicle. A component may be an embedded system. A component may include one or multiple microcontrollers.

An “embedded system” is a component that is integrated (embedded) into/in a technical context. In the process, the component takes over monitoring, control, or regulation functions and/or is responsible for a form of data processing or signal processing.

A “(dedicated) control unit” is a component that (exclusively) controls a function of a vehicle. A control unit may take over, for example, an engine control, a control of a braking system, or a control of an assistance system. A “function” may be defined on various levels of the vehicle (for example, an individual sensor or actuator, or also a plurality of assemblies that are combined to form a larger functional unit, may be used for a function).

The term “software” or “software component” may in principle be any part of software of a component (a control unit, for example) of the present disclosure. In particular, a software component may be a firmware component of a component of the present disclosure. “Firmware” is software that is embedded in (electronic) components, where it performs basic functions. Firmware is functionally fixedly connected to the particular hardware of the component (so that one is not usable without the other). Firmware may be stored in a nonvolatile memory such as a flash memory or an EEPROM.

The term “update information” or “software update information” encompasses any data which, directly or after appropriate processing steps, form a software component of a component according to the present disclosure. The update information may contain executable code or code yet to be compiled (which is stored in the memory of the component in question).

In the present disclosure, the term “manipulation” encompasses any change in software of a component of a vehicle. The change may be the consequence of an attack (i.e., the deliberate influence by a third party), or also the consequence of a random or inadvertent action.

The term “vehicle” encompasses any device that transports passengers and/or cargo. A vehicle may be a motor vehicle (a passenger car or a truck, for example), or also a rail vehicle.

However, floating and flying devices may also be vehicles. Vehicles may be operated or assisted at least semi-autonomously.

A “vehicle electrical system” may be any internal network of a vehicle via which components of the vehicle communicate. In some examples, a vehicle electrical system is a local area network. A vehicle electrical system may use one or multiple local area communication protocols (for example, two or more local area communication protocols). The local area communication protocols may be wireless or wired communication protocols. The local area communication protocols may include a bus protocol (CAN, LIN, MOST, FlexRay, or Ethernet, for example). The local area communication protocols may include a Bluetooth protocol (for example, Bluetooth 5 or later) or a WLAN protocol (for example, a protocol of the IEEE-802.11 family, for example 802.11h or a later protocol). A vehicle electrical system may contain interfaces for communicating with systems outside the vehicle, and may thus also be integrated into other networks. However, the systems outside the vehicle and the other networks are not part of the vehicle electrical system.

The expression “recognizing a possibility . . . ” means that certain occurrences (for example, signals or the absence thereof) are interpreted according to predetermined rules in order to recognize a state in which a manipulation of the software may be present.

### BRIEF DESCRIPTION OF THE DRAWINGS

FIG. 1 is a flowchart illustrating the techniques of an example embodiment of the present invention.

FIG. 2 shows components of a vehicle electrical system of a vehicle in which the techniques of the present invention may be used.

FIG. 3 shows various weak points of a vehicle electrical system of a vehicle.

FIG. 4 shows the vehicle electrical system according to FIG. 2 in which a first component has been manipulated.

FIG. 5 shows the vehicle electrical system according to FIG. 2 in which the manipulation of the first component has been remedied, according to an example embodiment of the present invention.

### DETAILED DESCRIPTION OF EXAMPLE EMBODIMENTS

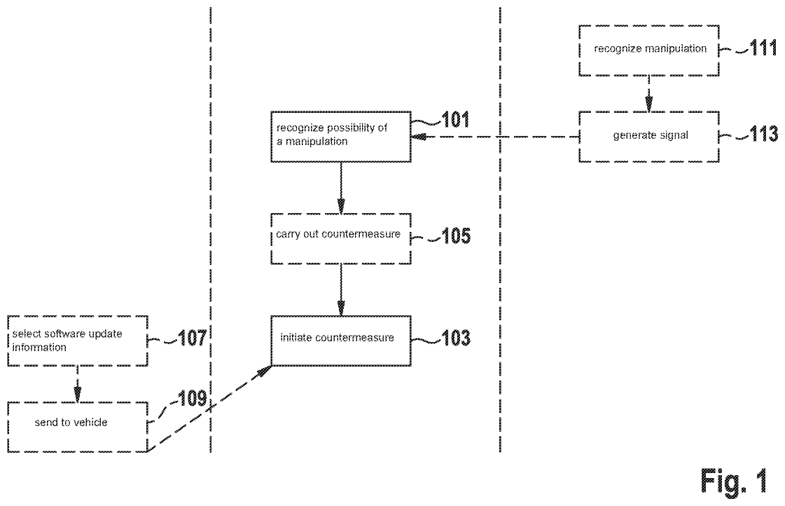

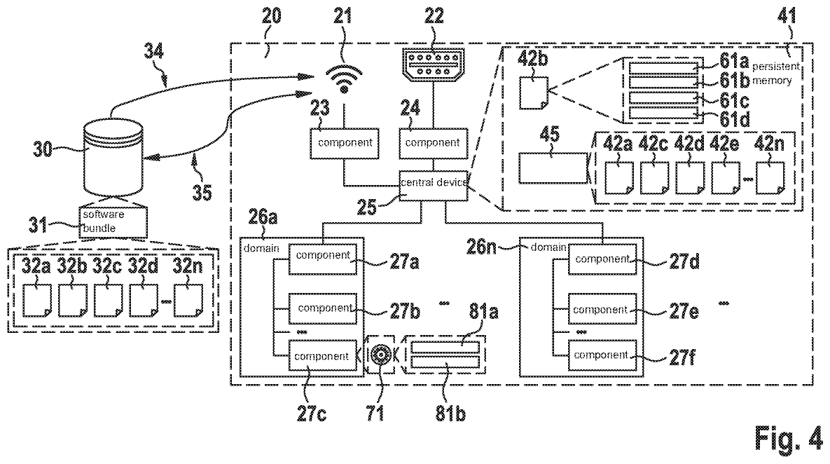

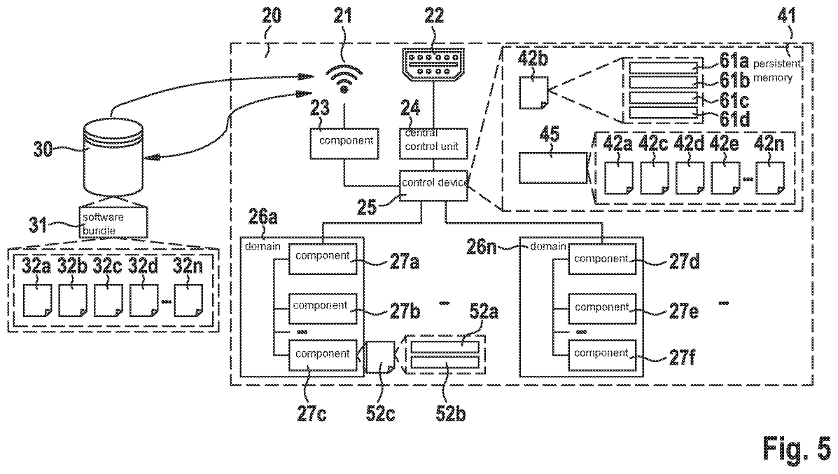

A vehicle in which the techniques of the present disclosure may be carried out, and the basic aspects of the techniques of the present disclosure, are initially discussed with reference to FIGS. 1 through 3. Further aspects of the central device for mitigating a manipulation of software are explained with reference to FIGS. 4 and 5.

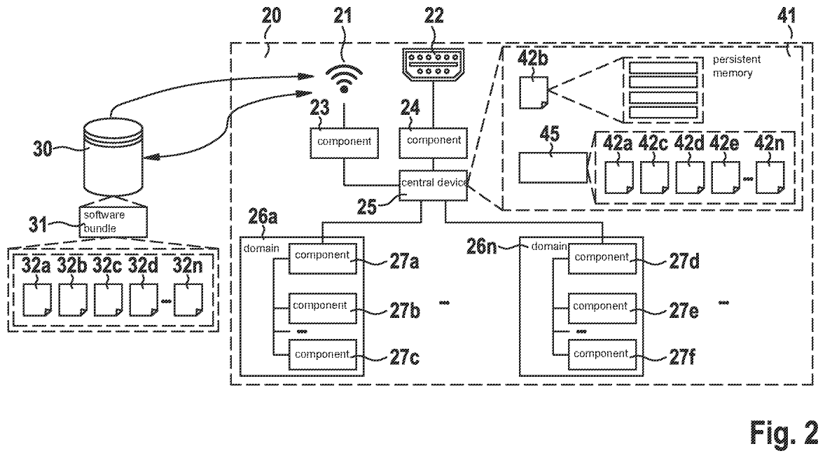

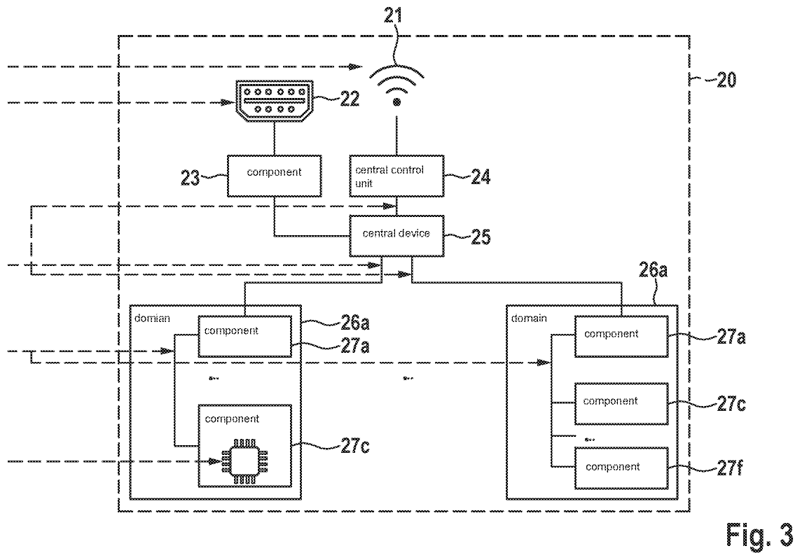

FIG. 1 is a flowchart illustrating the techniques of the present disclosure. FIG. 2 shows components of a vehicle electrical system of a vehicle in which the techniques of the present disclosure may be used. FIG. 3 illustrates various weak points of a vehicle electrical system of a vehicle.

The middle column in FIG. 1 shows steps which in some examples may be carried out by a central device (or in other examples, also by other components) for mitigating a manipulation of software. The right column shows steps that are carried out by a certain component (or a group of components) of the vehicle electrical system (excluding the central device for mitigating a manipulation of software). The left column shows steps that are carried out by a remote system (i.e., outside the vehicle).

The techniques of the present disclosure include recognizing 101 the possibility of a manipulation of the software of a first component 27c of a plurality of components of a vehicle electrical system of a vehicle 20. FIGS. 2 and 3 schematically show a vehicle 20. Vehicle 20 is equipped with a vehicle electrical system that connects a plurality of components 21 through 24, 25, 27a through f of vehicle 20 (the vehicle electrical system may be designed as described above).

Vehicle 20 includes a central device 25 for mitigating a manipulation of software, and which recognizes the possibility of the manipulation. The central device is thus part of the vehicle electrical system (i.e., is also part of the vehicle and moves along with it). Central device 25 for mitigating a manipulation of software may be designed to mitigate the manipulation of software in each of plurality 21 through 24, 27a through f of components of the vehicle electrical system.

In some examples, central device 25 for mitigating a manipulation of software is integrated into a central communication interface of vehicle 20. The central communication interface may be designed to function as a data distributor for the communication within vehicle 20 and/or communication with the outside world via a communication interface 21, 22. The central communication interface may support different communication protocols (for communication in the vehicle electrical system or communication with external systems) and/or may implement safety functions. In other examples, the central device for mitigating a manipulation of software may be integrated into other components (further examples are discussed below) or may be designed as an independent component.

In some examples, the recognition may include the reception of a signal that indicates a manipulation of the software of a first component 27c of a plurality of components of a vehicle electrical system of a vehicle 20. The signal may be generated in central device 25 itself for mitigating a manipulation of software and/or in some other device.

Additionally or alternatively, the recognition may include the recognition of an absence of an (expected) signal (for example, by the first component or a component that monitors the first component). The vehicle electrical system may be designed for the plurality of components 21 through 24, 25, 27a through f or other components to send signals that indicate that no manipulation of the software of the particular component of the plurality of components 21 through 24, 25, 27a through f is present (for example, regularly or upon occurrence of certain events such as start-up of a component).

Additionally or alternatively, the recognition may also include processing of other state information of the vehicle electrical system in order to recognize the possibility of a manipulation of the software of the first component.

In response to recognizing the possibility of a manipulation of the software of first component 27c of a plurality of components of a vehicle electrical system of a vehicle 20 (for example, receiving a signal or recognizing the absence of a signal), a countermeasure for mitigating the manipulation of the first component is initiated by central device 103 for mitigating a manipulation of software. The countermeasure for mitigating the manipulation of the software of first component 27c is subsequently carried out 105 (for example, by the central device for mitigating a manipulation of software and/or another component of the vehicle electrical system). The countermeasure includes a measure for preventing a repetition of the manipulation, which is selected based on an analysis of information concerning data traffic in the vehicle electrical system that took place before the possibility of a manipulation was recognized.

The analysis and/or the selection may be carried out by central device 25 for mitigating a manipulation of software. In other examples, the analysis and/or the selection may be carried out by one or multiple other components of the vehicle. In yet other examples, the analysis and/or the selection may be carried out by a remote system 30. In any case, the analysis and/or the selection may take place automatically (i.e., without participation by a user). For this purpose, the components that carry out the analysis and/or the selection may be equipped with appropriate functionalities (for example, may be defined in software). The analysis function and/or the selection function may by implemented in any possible form. For example, a rule-based algorithm may be executed. In other examples, a machine learning module may carry out the analysis and/or the selection. The analysis and the selection may be carried out within a predetermined time (for example, less than five minutes) after recognizing the manipulation.

In some examples, the analysis may include finding a weak point of the vehicle electrical system of a vehicle 20. A weak point may be a part of the vehicle electrical system (for example, one or multiple components of the vehicle electrical system) via which it was possible to carry out the recognized manipulation.

In some examples, the analysis may include analyzing the content of the data traffic that took place before the possibility of a manipulation was recognized. Thus, for example, it may be determined which portions of the data traffic include data for programming operations (for example, software components or other contents for programming components, for example signatures that are typical for these data). Additionally or alternatively, the analysis may include finding programming operations in the data traffic that took place before the possibility of a manipulation was recognized. Additionally or alternatively, it may also be determined which portions of the data traffic contained contents differing from known and/or expected contents. For example, a certain portion of the data traffic may have contained more extensive and/or different types of data than expected. Additionally or alternatively, data traffic may have taken place in portions of the vehicle electrical system in which no data traffic was to be expected at a certain point in time. These evaluations may allow conclusions that the identified data traffic was data traffic via which the software of the first component was manipulated.

Additionally or alternatively, the analysis may include determining the type of recognized manipulation. In some examples, determining the type of manipulation may include determining a vehicle interface via which data traffic took place before the possibility of a manipulation was recognized (for example, the data traffic with certain contents as described above). Additionally or alternatively, determining the type of recognized manipulation may include determining a path of the data traffic with respect to manipulated first component 27c and/or determining a source of the data traffic.

With reference to FIG. 3, aspects of determining the type of recognized manipulation are explained in greater detail below. FIG. 3 illustrates various weak points of a vehicle electrical system of a vehicle 20 that may be exploited by intruders for various types of manipulation.

In some examples, it may be determined that data traffic via a certain interface 21, 22 of vehicle 20 (symbolized in FIG. 3 by the arrows leading to interfaces 21, 22) preceded a recognized manipulation. The certain interface may be a wireless interface 21, but in other examples may also be a wired interface 22 (for example, an interface to the on-board diagnostics). The vehicle electrical system may include multiple wireless interfaces and/or wired interfaces. The information concerning the identified interface may be used to select the measure for preventing the repetition.

Additionally or alternatively, it may be recognized that data traffic from a certain component of the vehicle electrical system (once again symbolized in FIG. 3 by arrows ending in the vicinity of the particular component) preceded the recognized manipulation. This component may be, for example, a central communication interface 25 of the vehicle electrical system. In other examples, the component may be a central control unit 24 of the vehicle. In yet other examples, the component may be a head unit of an infotainment system of vehicle 20. In yet other examples, the component may be a central computer (vehicle computer) of the vehicle electrical system (the vehicle electrical system may contain a plurality of central computers (vehicle computers)). A central computer (vehicle computer) may have (significantly) higher performance than dedicated control units of the vehicle electrical system, and may take over the tasks of multiple control units (possibly in multiple of the above-mentioned domains).

In yet other examples, the vehicle may be subdivided into multiple functional and/or local domains of vehicle 20. A functional domain may include various components of a vehicle that take part in providing a certain function of the vehicle (for example, engine control, control of the drive train, infotainment, air conditioning, etc.). A local domain may include various components of a vehicle that are physically situated in a certain area of the vehicle (for example, “right rear,” “left front,” “interior front,” etc.). A domain may contain a component 27a, 27d that functions as a central communication node for particular domain 26a through n and/or takes over control functions for particular domain 26a through n. A central communication node for a domain may likewise be recognized as a component from which data traffic preceded the recognized manipulation. In some examples, a component (for example, one of the components described above) may be determined as the source of the data traffic via which the software component for manipulating first component 27c was introduced. The information concerning the identified component may be used to select the measure for preventing the repetition.

Additionally or alternatively, it may also be recognized that data traffic from an external source to the vehicle preceded the recognized manipulation.

In some examples, the analysis may include establishing a temporal relationship between a certain data traffic and recognizing the possibility of a manipulation. For example, the data traffic may have taken place less than a predetermined time before the manipulation of the software of first component 27 was recognized (for example, less than five minutes).

If the type of recognized manipulation has been determined, a suitable measure for preventing the repetition may be selected.

In some examples, the measure includes preventing or limiting certain types of data traffic in vehicle 20. In some examples, preventing or limiting may include blocking a communication of a certain component via the vehicle electrical system (for example, communication that comes from the certain component).

The certain component may be one of the above-described components, for example. Alternatively, the preventing or limiting may include blocking certain types of communication of a certain component. For example, the certain component may be prohibited from sending data for programming operations.

Alternatively or additionally, receiving data may still be allowed while sending data is prevented or limited (or vice versa). Alternatively or additionally, communication may also be prevented or limited via a first protocol, while communication via a second protocol is still allowed. Alternatively or additionally, the data traffic from the certain component may also be limited to certain contents. Additionally or alternatively, the preventing or limiting may also pertain to certain external sources that send data to the vehicle. The communication with one or multiple external sources may thus be limited or prevented.

Alternatively or additionally, the measure may include switching off or limiting certain components of vehicle 20. In some examples, the certain component is an interface of the vehicle electrical system of vehicle 20 (for example, a wireless interface 21 or a wired interface 22). In other examples, the certain component is a component within the vehicle electrical system (for example, one of the components described above). The limiting of the functionality of the certain component may include switching off one or multiple (sub)functions of the certain component. For example, the certain component may continue to carry out a control function while a communication function is switched off. A switched-off function of the certain component may be taken over by another component of the vehicle electrical system.

In all of the examples described above, the measure for preventing the repetition of the manipulations may intervene in the vehicle electrical system in a targeted manner. Thus, in some cases the risk of a repetition of the manipulation may be reduced without the need for extensive interventions in the operation of the vehicle.

In some examples, the measure for preventing the repetition of the manipulation may be carried out not only in the vehicle in which the possibility of a manipulation has been recognized, but also in other vehicles (even if the software of the other vehicle has not been manipulated or a possibility of a manipulation has not been recognized; thus, in this case, this does not necessarily involve a repetition of the manipulation in the same vehicle, but instead is a repetition (of the type) of the manipulation in another vehicle). In other words, recognizing the possibility of a manipulation of the software of a first component in (first) vehicle 20 may trigger carrying out the measure in one or multiple other vehicles (for example, vehicles in which a component corresponding to the first component is present, for example, vehicles of the same type). In some examples, this takes place regardless of whether a possibility of a manipulation of the software of a first component has been recognized in the one or multiple other vehicles. In this way, a plurality of vehicles may be secured against a certain manipulation (for example, vehicles in a certain geographical area and/or of a certain type). The measure for preventing the repetition of the manipulation may likewise be initiated in the other vehicle by a central device for mitigating a manipulation. In some examples, the other vehicle may be prompted to initiate the measure (via a remote system, for example). In other examples, a vehicle-to-vehicle communication may take place, within the scope of which (first) vehicle 20 informs the other vehicle of recognizing the possibility of a manipulation of the software of first component 27c of a plurality of components 27a through f of a vehicle electrical system of a vehicle 20. The measure may likewise be subsequently carried out in the other vehicle.

In some examples, the results of the analysis of information concerning data traffic in the vehicle electrical system may be logged, and the logged results may be provided for recognizing manipulations (for example, provided to one or multiple (manipulation) detection devices of the vehicle, which may be situated in the vehicle or in an external system 30, for example the (manipulation) detection devices described below). The (manipulation) detection devices may utilize the information in future detection processes. In this way, the likelihood that a repeated manipulation of a certain type is recognized may be increased (if the techniques for preventing the repeated manipulation of the present disclosure should fail).

In some examples, the methods of the present disclosure may further include deactivating the measure in response to an update of the vehicle electrical system of vehicle 20. For example, at a certain point in time (for example, during a repair shop visit or via a wireless interface) the cause of a weak point may be eliminated (for example, by updating the software of the component that forms the weak point). For example, switching off or limiting the component, or preventing or limiting certain types of data traffic in vehicle 20, may be subsequently cancelled.

Aspects of central device 25 for mitigating a manipulation of software are explained in the following paragraphs. Central device 25 for mitigating a manipulation of software is shown in the example from FIG. 2. In some cases, the vehicle may contain only one central device 25 for mitigating a manipulation of software, which is designed to mitigate manipulations of the plurality of components 21 through 24, 27a through f (for example, of all components of a vehicle for which a manipulation of software may be remedied, or a subset of these components). In other examples, a vehicle may include multiple central devices for mitigating a manipulation of software, which are part of the vehicle electrical system and in each case are associated with a plurality of the components of the vehicle electrical system (i.e., may remedy manipulations in the software of the associated components). In any case, however, the central devices for mitigating a manipulation of software are separated from the associated components. In some cases, central device 25 for mitigating a manipulation of software may also be designed to mitigate a manipulation of its own software and/or of the software of a component into which central device 25 for mitigating a manipulation of software is integrated.

In the example from FIG. 2, a plurality of components, for which manipulations of their software may be remedied using the techniques of the present disclosure, include a plurality of control units 27a through f. As described above, the techniques of the present disclosure are not limited to control units, but, rather, are usable in principle for any component of a vehicle electrical system of vehicle 20. However, since control units 27a through f in vehicles generally have only limited hardware resources and/or functionalities, in some cases the techniques of the present disclosure may be particularly advantageous for control units.

Control units 27a through f are subdivided into multiple domains 26a through n in FIG. 2. The domains may be functional and/or local domains of vehicle 20. A functional domain may include various components of a vehicle that take part in providing a certain function of the vehicle (for example, engine control, control of the drive train, infotainment, air conditioning, etc.). A local domain may include various components of a vehicle that are physically situated in a certain area of the vehicle (for example, “right rear,” “left front,” “interior front,” etc.).

A domain 26a through n may in turn contain a component 27a, 27d that functions as a central communication node for particular domain 26a through n and/or takes over control functions for particular domain 26a through n. In some examples, a central device for mitigating a manipulation of software may be part of component 27a, 27d that functions as a central communication node for particular domain 26a through n, and/or takes over control functions for particular domain 26a through n. This central device for mitigating a manipulation of software may be provided in addition to further central devices for mitigating a manipulation of software (for example, a central device for mitigating a manipulation of software as part of a central communication interface of the vehicle electrical system), or as a single central device for mitigating a manipulation of software (see above explanations). Alternatively or additionally, a central device for mitigating a manipulation of software may also be designed as part of a central control unit 24 of the vehicle. Alternatively or additionally, a central device for mitigating a manipulation of software may also be provided as part of a head unit of an infotainment system of vehicle 20 (not shown in FIG. 2). Alternatively or additionally, a central device for mitigating a manipulation of software may also be provided as part of a central computer (vehicle computer) of the vehicle electrical system (the vehicle electrical system may contain a plurality of central computers (vehicle computers)). A central computer (vehicle computer) may have (significantly) higher performance than dedicated control units of the vehicle electrical system, and may take over the tasks of multiple control units (possibly in multiple of the above-mentioned domains).

In addition, vehicle 20 may include a central persistent memory 41 (i.e., a memory that stores its information in the vehicle for a long period of time, for example longer than a day or longer than a week and/or during an idle state of the vehicle). In some examples, persistent memory 41 may include a flash memory. In the example from FIG. 2, persistent memory 41 is situated in the central communication interface of vehicle 20 or is directly connected to same. As discussed, central device 25 for mitigating a manipulation of software may likewise be situated in the central communication interface of vehicle 20. Even if a central device for mitigating a manipulation of software is (additionally or alternatively) situated in another component, a persistent memory may additionally or alternatively be situated in the same component. In this way, data that are stored in the persistent memory by the central device for mitigating a manipulation of software may be used for mitigating manipulations. However, in other examples, a central device for mitigating a manipulation of software and a persistent memory may also be situated in different components of the vehicle electrical system (and the central device for mitigating a manipulation of software may access the persistent memory via the network).

Persistent memory 41 may be designed to simultaneously store software components 42a, 42c through n for each component of the plurality of components 27a through f. For this purpose, persistent memory 41 may be designed with a memory capacity of greater than 256 MB (preferably greater than 5 GB).

The countermeasure against the manipulation may include resetting of the software of a component for which a manipulation of its software has been recognized (also referred to as “first component” in the present disclosure), for example, using software components 42a, 42c through n for the particular component stored in central persistent memory 41. Further aspects of this further countermeasure are discussed in greater detail below with reference to FIGS. 4 and 5.

In some examples, software components 42a, 42c through n that are contained in central persistent memory 41 may be based on software update information 32a, 32c through n for each component of the plurality of components 27a through n (for example, generated from software update information 32a, 32c through n or corresponding to same).

Software update information 32a, 32c through n may be received via an interface 21 of vehicle 20. Interface 21 may be a wireless interface (as shown in FIG. 2), but in other examples may also be a wired interface 22 (for example, an interface to the on-board diagnostics). The vehicle may be designed to receive software update information 32a, 32c through n from remote system 30 via one of interfaces 21, 22. As shown in FIG. 1, remote system 30 may select 107 software update information 32a, 32c through n for the vehicle in question and send (109) it to vehicle 20 via one of interfaces 21, 22. Remote system 30 may be any arbitrary system that is suitable for providing software update information 32a, 32c through n (for example, a cloud memory and/or a distributed system). In addition to providing software update information 32a, 32c through n, remote system 30 may take over further functions during operation of the vehicle (for example, monitoring and/or control functions for vehicle 20).

In some examples, software update information 32a, 32c through n for a plurality of components (for example, control units 27a, c through n) is contained in a software bundle or software container 31 (i.e., the software update information is provided bundled). The software bundle or software container 31 (often having a significant size) is transmitted to vehicle 20 at a certain point in time. As described, transmitted software update information 32a, 32c through n for updating the software of the plurality of components 27a through f is used in vehicle 20. For this purpose, software update information 32a, 32c through n obtained from remote system 30 may run through one or multiple preparatory steps (for example, unpacking, verifying a signature, etc.).

Additionally or alternatively, software update information 32a, 32c through n (for example, in a software bundle or software container) may be received via a wired interface 22.

Before or after any preparatory steps, software update information 32a, 32c through n may be stored in persistent memory 41 as software components 42a, 42c through n for the plurality of components 27a, c through n (for example, before it is used for updating the software of components 27a, c through n). Stored software components 42a, 42c through n for the plurality of components 27a, c through n are then available to central device 25 for mitigating a manipulation of software for mitigating a manipulation in the plurality of components 27a, c through n. This mitigation may take place after the updating of the software of each component of the plurality of components 27a, c through n is completed (for example, in a time period up to receipt of further software update information 32a, 32c through n).

In some examples, the techniques of the present disclosure may thus be used in components that are already present in the vehicle, for example, a persistent memory 41 that is used in an update process of the software of vehicle 20. In some cases, this may result in a significant saving of components (as described above, the memory required for storing a software bundle or software container 31 with software update information 32a, 32c through n may assume a significant size). Additionally or alternatively, providing the individual components with additional resources (memory, for example) may be avoided, which may likewise reduce the complexity and thus the susceptibility to errors and/or costs. Additionally or alternatively, in many situations the information in persistent memory 41 may also be available quickly, and independently of the usability of a communication channel of the vehicle. This may increase the response time of the method for mitigating a manipulation.

In the techniques of the present disclosure, the countermeasure for mitigating may be carried out essentially without the use of systems outside vehicle 20 (for example, remote system 30). For example, the countermeasure may be initiated by central device 25 for mitigating a manipulation of software, without the need for communication with systems outside vehicle 20 (during this operation, vehicle 20 may in fact communicate with a system outside vehicle 20 for other purposes). Additionally or alternatively, central device 25 for mitigating a manipulation of software (or some other component of the vehicle electrical system) may carry out a countermeasure without the need for communication with systems outside vehicle 20.

In some examples, the techniques of the present disclosure may include selecting a further countermeasure among a plurality of further countermeasures, based on context information for the vehicle. The context information may include information concerning an operating state of vehicle 20 and/or concerning predetermined rules for operating vehicle 20.

An operating state may be a driving state of the vehicle (for example, fast driving, slow driving, carrying out certain driving maneuvers, etc.), but also an operating state during which the vehicle is not traveling. Alternatively or additionally, the context information for vehicle 20 may include surroundings information and/or state information of the components of the vehicle.

The rules for operating vehicle 20 may contain predetermined safety criteria (which in turn may be a function of operating states of vehicle 20 and which establish, for example, when and with which dependencies a further countermeasure for a certain component is allowed to be initiated and carried out).

The context information may be at least partially stored in a memory of central device 25 for mitigating a manipulation of software (for example, central persistent memory 41) for use in selecting a further countermeasure (in particular the portion of the context information that includes information concerning predetermined rules for operating vehicle 20). In some examples, the context information may be updated from outside vehicle 20 (for example, as part of software update information 32b for central device 25 for mitigating a manipulation of software or a component in which central device 25 for mitigating a manipulation of software is situated).

In some examples, various further countermeasures may be available for mitigating certain manipulations of the software of components 27a, c through n (the possible further countermeasures are described in greater detail below). The context information may now be used to select one of the available further countermeasures. In some examples, among multiple available further countermeasures, the countermeasure that allows the greatest possible restoration of a setpoint state of the component may be selected (i.e., that remedies the manipulation to the greatest possible extent). On the other hand, available further countermeasures may be excluded in some situations, based on rules contained in the context information (for example, when a certain safety criterion has been violated).

For example, a first further countermeasure, although it allows a more extensive mitigation of the manipulation than a second further countermeasure, on the other hand may require a more in-depth intervention into the components of the vehicle (and thus, a greater risk for disturbances that may be caused by the mitigation process itself). A second further countermeasure, although it allows a less extensive mitigation of the manipulation compared to the first further countermeasure, on the other hand may require a less in-depth intervention into the components of the vehicle. In this case, the first further countermeasure may be selected in a first context (expressed by the context information), and the second further countermeasure may be selected in a second context (expressed by the context information). In one illustrative example, the first context may be a context in which the vehicle is traveling fast, and the second context may be a context in which the vehicle is stationary. In other cases, the context information may include a safety criterion whose fulfillment prohibits carrying out the first further countermeasure in a first situation, but allows it in a second situation.

In some examples, the further countermeasures may include an immediate (for example, within five minutes or within one minute) resetting of the software of first component 27a, c through f, using software component 42a, c through n that is stored in central persistent memory 41 (for example, generated based on the received software update information) for component 27a, c through f for which a manipulation has been recognized, and a later resetting of the software of component 27a, c through f, using software components 42a, c through n for particular component 27a, c through f. In turn, the immediate resetting may be ruled out in certain contexts (for example, due to safety criteria). For example, the later resetting may take place in a time period up to the next boot-up process of particular component 27a, c through f.

Further aspects of the techniques of the present disclosure are explained below with reference to FIGS. 4 and 5. FIG. 4 shows the vehicle electrical system according to FIG. 2, in which a first component 27c has been manipulated. FIG. 5 shows the vehicle electrical system according to FIG. 2, in which the manipulation of first component 27c has been remedied.

Several aspects of the detection of the manipulation of the software of a component 27a, c through f of vehicle 20 are initially explained in greater detail. As mentioned above, the techniques of the present disclosure may involve recognizing a possibility of a manipulation of the software of a component of a plurality of components of a vehicle electrical system, which in some examples involves reception of a signal. This signal may be generated in various ways.

A manipulation of software of a component 27a, c through f may be initially detected. This detection may take place locally using appropriate (manipulation) detection devices of the component in question.

In FIG. 4, the software of one of control units 27c (the “first component” in some examples of the present disclosure) has been manipulated. A manipulated software component 71 has been introduced.

A (manipulation) detection device 81a of control unit 27c may recognize this manipulation and may generate an appropriate signal for central device 25 for mitigating a manipulation of software (also see steps 111 and 113 in FIG. 1). This signal may then be processed as discussed above in order to initiate and carry out a mitigation.

In other examples or in addition, a (manipulation) detection device 61b of the central communication interface of vehicle 20 may (remotely) detect the manipulation of control unit 27c and may generate the signal for central device 25 for mitigating a manipulation of software (which in the example from FIG. 4 is likewise situated in the central communication interface of vehicle 20). In some examples, central device 25 for mitigating a manipulation of software is thus also designed for a central detection of the manipulation of the software of a plurality of components 27a, c through f of the vehicle electrical system.

In other examples or in addition, a detection device of remote system 30 may (remotely) detect the manipulation of control unit 27c and may generate the signal for central device 25 for mitigating a manipulation of software. In this example, the signal may be received via an interface of the vehicle. However, if the detection of the manipulation also takes place within the vehicle, a time period up to the mitigation of the manipulation may be shortened in some cases.

The various detection devices 81a, 61b (in particular detection devices 81a, 61b situated in the vehicle) may be detection devices that are already present in the (vehicle electrical system) network. As described above, manipulations of the software may also be recognized in some conventional methods.

The detection of the manipulation may take place in any possible manner. For example, software may be checked upon start-up (secure boot) and/or during operation (run-time manipulation detection) with the aid of one or multiple methods for checking the authenticity and/or genuineness of the software (for example, using one or multiple digital signatures).

In other examples, a signal for which the possibility of the manipulation is recognized if the signal is absent may be generated by the components described in the preceding paragraphs. For example, a (manipulation) detection device 81a of control unit 27c may generate a signal (for example, routinely or when certain events occur), whose absence may indicate a manipulation of the software of control unit 27c.

Further aspects of the further countermeasure of resetting the software of first component 27c, using a software component 42c for first component 27c that is stored in central persistent memory 41, are now discussed with reference to FIGS. 4 and 5.

Central device 25 for mitigating a manipulation may select a further countermeasure based on a detection of the manipulation of first component 27c. In the example from FIGS. 4 and 5, a resetting of the software of first component 27c is selected as the further countermeasure. The resetting may encompass bringing the software to a last authenticated state. This may include deleting and/or overwriting all or part of the software of first component 27c (for example, a control unit). The deleting and/or overwriting of all or part of the software of first component 27c may be carried out remotely (i.e., via a connection of the vehicle electrical system) by central device 25 for mitigating a manipulation. In this way, manipulated software component 71 or portions 81a, 81b thereof may be replaced by an authentic (i.e., unmanipulated) software component 52c or portions 53a, 53b thereof in order to remedy the manipulation.

Authentic (i.e., unmanipulated) software 52c may be retrieved from persistent memory 41. As mentioned above, persistent memory 41 may store software component 42c in a directly usable form, or in a form that can be used only after one or multiple processing steps for resetting manipulated software component 71 of first component 27c.

In some examples, central device 25 for mitigating a manipulation may carry out measures for ensuring the authenticity of software components 42a, c through n used for resetting the software of the components. For example, an authenticity check may be carried out prior to using a software component 42a, c through n (for example, based on a digital signature or some other security feature). For the authenticity check, central device 25 for mitigating a manipulation may rely on functionalities of the component into which central device 25 for mitigating a manipulation is integrated.

In some examples, persistent memory 41 may contain more than one version of a software component for a certain component of the vehicle electrical system. In this case, central device 25 for mitigating a manipulation may select one of the versions (for example, a present version of the software component).

A countermeasure for mitigating the manipulation of a first component 27c of the vehicle electrical system was discussed in the preceding paragraph, with reference to FIGS. 4 and 5. However, central device 25 for mitigating a manipulation is configured to initiate countermeasures concerning the manipulation of the software of one or multiple further components of the plurality of components 27a, d through f at some other point in time or concurrently with the mitigation of the manipulation of the software of first component 27c.

In some examples, central device 25 for mitigating a manipulation is designed to recognize the possibility of a manipulation of the software of a further component 27a, d through f of the plurality of components of the vehicle electrical system, and to initiate a further countermeasure for mitigating the manipulation of further component 27a, d through f. The detection of the manipulation, the initiation, and the carrying out of the countermeasures may proceed as described above. For example, a manipulated software component of further component 27a, d through f may be reset.

In this way, a single central device may ensure mitigation of a manipulation of a plurality of components that are remote from it in the vehicle electrical system (for example, control units in various domains), i.e., may remedy manipulations of software of the plurality of components.

A resetting of software of a component has been described in the preceding paragraphs as an example of a further countermeasure that is initiated by the central device for mitigating a manipulation and carried out in the vehicle electrical system.

In some examples, the central device for mitigating a manipulation may alternatively or additionally initiate other further countermeasures. The further countermeasures are likewise carried out in the vehicle electrical system.

In some examples, the further countermeasure against the manipulation may include blocking a communication via the vehicle electrical system of first component 27c (whose software is manipulated). Blocking the communication may prevent manipulated software of first component 27c from causing damage via the vehicle electrical system. On the other hand, manipulated software may still carry out a function of first component 27c (for example, for a certain period of time). For this reason, in some cases blocking the communication via the vehicle electrical system of first component 27c may be preferred over resetting the software of first component 27c (for example, in a context in which a failure of first component 27c, at least for the short term, is not tolerable or desirable). The further countermeasure of resetting the software of first component 27c may be initiated and carried out following the further countermeasure of blocking the communication of first component 27c (for example, in an altered context).

Alternatively or additionally, the further countermeasure against the manipulation may include blocking a communication of a group of components via the vehicle electrical system that contains first component 27c. In the example from FIG. 3, first component 27c may be contained in a first domain 26a along with further components 27a, b. Blocking the communication of a group of components via the vehicle electrical system is similar to blocking the individual component, as described above. Here as well, damage from the group of components in the vehicle electrical system may be prevented. Also in the case of blocking the communication of a group of components via the vehicle electrical system, the further countermeasure of resetting the software of first component 27c may be initiated and carried out at a later point in time (for example, in an altered context).

In the preceding paragraphs, the techniques of the present disclosure have been frequently described with reference to the particular methods.

Moreover, the present disclosure relates to a system that is designed to carry out the methods of the present disclosure. The system may include one or multiple components of the vehicle electrical system of the vehicle (for example, may be integrated into same). The vehicle electrical system may also include devices that are only temporarily contained in the vehicle electrical system (for example, a mobile device that is situated in the vehicle and integrated into the vehicle electrical system). In other examples, the system may also encompass a remote system.

Furthermore, the present disclosure relates to a vehicle electrical system for a vehicle that includes at least one central device for mitigating a manipulation of software according to the present disclosure, and a plurality of components of the vehicle electrical system. The vehicle electrical system may be designed to carry out the techniques of the present disclosure (as described above). The vehicle electrical system may also include devices that are only temporarily contained in the vehicle electrical system (for example, a mobile device that is situated in the vehicle and integrated into the vehicle electrical system).

As described above, the central device for mitigating a manipulation of software may be a stand-alone device (i.e., a dedicated module with its own hardware and software resources, which is part of the vehicle electrical system and which may communicate with the other components of the vehicle electrical system). However, in other cases the central device for mitigating a manipulation of software may be integrated into some other (already present) component of the vehicle electrical system. The central device for mitigating a manipulation of software may be designed as a software module (which is incorporated into the software of the component). In other cases, the central device for mitigating a manipulation of software may include at least some dedicated hardware components (while it shares other hardware components of the component into which it is integrated). As likewise mentioned, the other component may be a central communication interface of the vehicle electrical system, a central computer (vehicle computer), or some other component including hardware with comparatively higher performance.

In some examples, an existing component of the vehicle electrical system (for example, a central communication interface of the vehicle or a domain of the vehicle, or a central computer of the vehicle, or a head unit of an infotainment system) may be configured as a central device for mitigating a manipulation of software by updating the software of the component of the vehicle electrical system.

The central device for mitigating a manipulation of software or the other component into which it is integrated may include at least one processor (optionally with multiple cores), and memory that includes commands which, when executed by the processor, carry out the steps of the methods of the present disclosure.

Moreover, the present disclosure relates to a vehicle that includes a system according to the present disclosure or that is a part of same, and/or that includes a vehicle electrical system according to the present disclosure.

Furthermore, the present disclosure relates to a computer program that is designed to carry out the methods of the present disclosure.

In addition, the present disclosure relates to a computer-readable medium (for example, a DVD or a solid state memory) that contains a computer program of the present disclosure.

Moreover, the present disclosure relates to a signal (for example, an electromagnetic signal according to a wireless or wired communication protocol) that encodes a computer program of the present disclosure.

What is claimed is:

1. A computer-implemented method, comprising:
recognizing a possibility of a manipulation of software of a first component of a plurality of components of a vehicle electrical system of a vehicle in a central device configured to mitigate a manipulation of software, the central device configured to mitigate a manipulation being part of the vehicle electrical system, and being configured to mitigate a manipulation of software in each component of the plurality of components of the vehicle electrical system;
initiating a countermeasure for mitigating the manipulation of the software of the first component by the central device configured to mitigate a manipulation; and
carrying out the countermeasure for mitigating the manipulation of the software of the first component, the countermeasure for mitigating the manipulation including a measure for preventing a repetition of the manipulation, the measure being selected based on an analysis of information concerning data traffic in the vehicle electrical system that took place before the possibility of a manipulation was recognized.

2. The method as recited in claim 1, wherein the analysis includes determining a type of manipulation.

3. The method as recited in claim 1, wherein the analysis includes finding a weak point of the vehicle electrical system of a vehicle.

4. The method as recited in claim 2, wherein determining the type of manipulation includes determining an interface of the vehicle via which data traffic took place before the possibility of a manipulation was recognized.

5. The method as recited in claim 1, wherein the analysis includes finding programming operations in data traffic that took place before the possibility of a manipulation was recognized.

6. The method as recited in claim 1, wherein the analysis includes establishing a temporal relationship between a certain data traffic and recognizing the possibility of a manipulation.

7. The method as recited in claim 1, wherein the measure includes one or multiple of the following:
preventing or limiting certain types of data traffic in the vehicle; and
switching off or limiting certain components of the vehicle.

8. The method as recited in claim 7, wherein the certain components include an interface of the vehicle electrical system of the vehicle.

9. The method as recited in claim 1, further comprising:
logging results of the analysis of information concerning data traffic in the vehicle electrical system; and
providing the logged results for recognizing manipulations.

10. The method as recited in claim 1, further comprising:
deactivating the measure in response to an update of the vehicle electrical system of the vehicle.

11. A system configured to:
recognize a possibility of a manipulation of software of a first component of a plurality of components of a vehicle electrical system of a vehicle in a central device configured to mitigate a manipulation of software, the central device configured to mitigate a manipulation being part of the vehicle electrical system, and being configured to mitigate a manipulation of software in each component of the plurality of components of the vehicle electrical system;
initiate a countermeasure for mitigating the manipulation of the software of the first component by the central device configured to mitigate a manipulation; and
carry out the countermeasure for mitigating the manipulation of the software of the first component, the countermeasure for mitigating the manipulation including a measure for preventing a repetition of the manipulation, the measure being selected based on an analysis of information concerning data traffic in the vehicle electrical system that took place before the possibility of a manipulation was recognized.

12. A vehicle electrical system for a vehicle, comprising:
a plurality of components of the vehicle electrical system that include a first component; and
a central device configured to mitigate a manipulation of software;
wherein the vehicle electrical system is configured to:
recognize a possibility of a manipulation of software of the first component in the central device, the central device being part of the vehicle electrical system, and being configured to mitigate a manipulation of software in each component of the plurality of components of the vehicle electrical system,
initiate a countermeasure for mitigating the manipulation of the software of the first component by the central device, and
carry out the countermeasure for mitigating the manipulation of the software of the first component, the countermeasure for mitigating the manipulation including a measure for preventing a repetition of the manipulation, the measure being selected based on an analysis of information concerning data traffic in the vehicle electrical system that took place before the possibility of a manipulation was recognized.

13. A vehicle, comprising:
a vehicle electrical system, including:
a plurality of components of the vehicle electrical system that include a first component, and
a central device configured to mitigate a manipulation of software,
wherein the vehicle electrical system is configured to:
recognize a possibility of a manipulation of software of the first component in the central device, the central device being part of the vehicle electrical system, and being configured to mitigate a manipulation of software in each component of the plurality of components of the vehicle electrical system,
initiate a countermeasure for mitigating the manipulation of the software of the first component by the central device, and
carry out the countermeasure for mitigating the manipulation of the software of the first component, the countermeasure for mitigating the manipulation including a measure for preventing a repetition of the manipulation, the measure being selected based on an analysis of information concerning data traffic in the vehicle electrical system that took place before the possibility of a manipulation was recognized.

14. A non-transitory computer-readable medium on which is stpred a computer program, the computer program, when executed by a computer, causing the computer to perform the following steps:
recognizing a possibility of a manipulation of software of a first component of a plurality of components of a vehicle electrical system of a vehicle in a central device configured to mitigate a manipulation of software, the central device configured to mitigate a manipulation being part of the vehicle electrical system, and being configured to mitigate a manipulation of software in each component of the plurality of components of the vehicle electrical system;
initiating a countermeasure for mitigating the manipulation of the software of the first component by the central device configured to mitigate a manipulation; and
carrying out the countermeasure for mitigating the manipulation of the software of the first component, the countermeasure for mitigating the manipulation including a measure for preventing a repetition of the manipulation, the measure being selected based on an analysis of information concerning data traffic in the vehicle electrical system that took place before the possibility of a manipulation was recognized.
